(19) United States
(12) Patent Application Publication
(10) Pub. No.: US 2008/0294845 A1
(43) Pub. Date: Nov. 27, 2008

(54) INFORMATION PROCESSING APPARATUS, INFORMATION PROCESSING METHOD, AND INFORMATION PROCESSING PROGRAM PRODUCT

(75) Inventor: Kensuke Kawajiri, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/027,269

(22) Filed: Feb. 7, 2008

(30) Foreign Application Priority Data
Feb. 7, 2007 (JP) 2007-028014

(51) Int. Cl. G06F 12/08

(52) U.S. Cl. 711/115; 711/E12.008

(57) ABSTRACT

An information processing apparatus includes a connection unit configured to connect a detachably attachable external storage device, a program storage unit configured to store a first program, a first memory control unit configured to store identification information used to identify the information processing apparatus in the external storage device in association with the first program stored in the program storage unit, a program acquisition unit configured to acquire a second program from the external storage device, and a second memory control unit configured to store the second program acquired by the program acquisition unit in the program storage unit.

### BACKGROUND OF THE INVENTION

1. Field of the Invention

The present invention relates to an information processing apparatus, an information processing method, and an information processing program product. In particular, the present invention relates to an information processing apparatus and an information processing method for retrieving a program or setting information from an external storage device.

2. Description of the Related Art

Hitherto, there has been developed a method for connecting an external storage device storing a program or the setting information to an information processing apparatus in order to download the program or the setting information from the external storage device to the information processing apparatus (Japanese Patent Application Laid-Open No. 2006-059190).

In this method, any program or setting information can be downloaded from the external storage device to the information processing apparatus while backing up programs or setting information originally stored in the information processing apparatus to the external storage device. As a result, if the information processing apparatus cannot appropriately operate with the downloaded program or setting information, the backed-up program or setting information can be reloaded to the information processing apparatus.

However, when the program or setting information can be backed up to the external storage device, there is a possibility that a user unintentionally downloads the program or setting information to other information processing apparatuses. Further, even if the backed-up program or setting information can be downloaded to any other information processing apparatus, the program or information might be downloaded to an unintended model of an information processing apparatus.

### SUMMARY OF THE INVENTION

The present invention is directed to an information processing apparatus and an information processing method which can back up a program or setting information to an external storage device to download the program or setting information that is backed up to the external storage device, to an appropriate information processing apparatus in accordance with identification information.

According to an aspect of the present invention, an information processing apparatus includes a connection unit configured to connect a detachably attachable external storage device, a program storage unit configured to store a first program, a first memory control unit configured to store identification information used to identify the information processing apparatus in the external storage device in association with the first program, a program acquisition unit configured to acquire a second program from the external storage device, and a second memory control unit configured to store the second program in the program storage unit.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a hardware configuration of an information processing apparatus according to an exemplary embodiment of the present invention.

FIG. 2 is a flowchart of an information processing method executed by an information processing apparatus according to an exemplary embodiment of the present invention.

FIG. 3 is a flowchart of an information processing method executed by an information processing apparatus according to an exemplary embodiment of the present invention.

FIGS. 4A and 4B illustrate setting information about a format depending on a memory.

FIG. 5 illustrates an example of a procedure for converting a setting file to a format not depending on a memory to generate a setting information file.

FIG. 6 is a flowchart of an information processing method executed by an information processing apparatus according to an exemplary embodiment of the present invention.

FIGS. 7A to 7C illustrate an example in which an inappropriate set value is described in a setting information file.

FIG. 8 is a flowchart of an information processing method executed by an information processing apparatus according to an exemplary embodiment of the present invention.

### DETAILED DESCRIPTION OF THE EMBODIMENTS

Various exemplary embodiments, features, and aspects of the invention will be described in detail below with reference to the drawings.

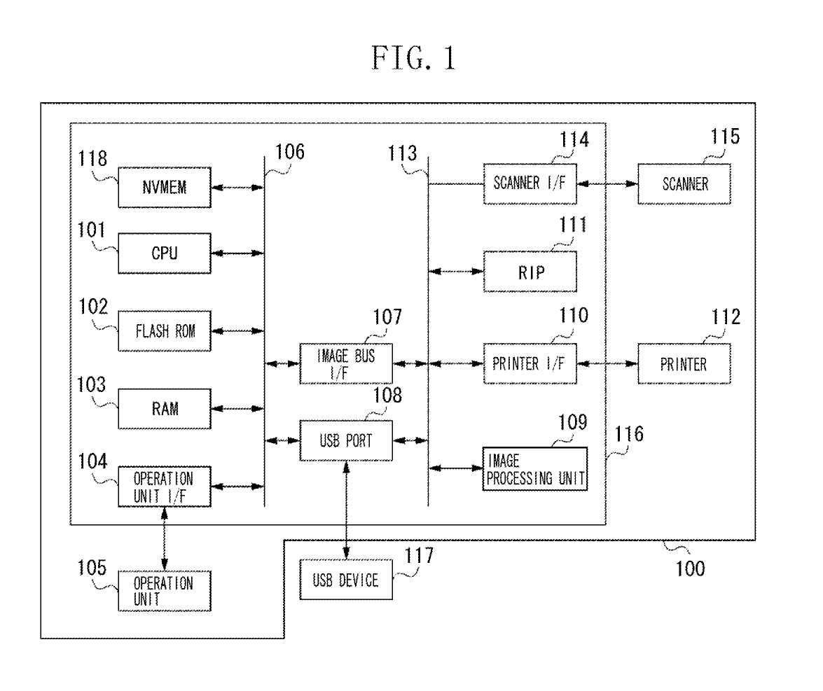

FIG. 1 illustrates a hardware configuration of an information processing apparatus 100 according to an exemplary embodiment of the present invention. The information processing apparatus 100 is an image forming apparatus having a printer function, a scanner function, a copier function, and a fax function.

The apparatus includes a controller unit 116 connected to an operation unit 105, a printer 112, and a scanner 115. The controller unit 116 causes the operation unit 105 to input/output information, causes the printer 112 to print an image corresponding to image data, and causes the scanner 115 to scan an image.

The controller unit includes a central processing unit (CPU) 101 for controlling the entire information processing apparatus, a flash read only memory (ROM) 102 as a rewritable nonvolatile memory for storing various programs to control the information processing apparatus, a random access memory (RAM) 103 that is a work memory used by the CPU 101, in other words, a program memory for temporarily storing a program or an image memory for temporarily storing image data, and an nonvolatile memory (NVMEM) 118 for storing setting information etc.

The setting information includes information about the number of copies, information about whether a hard disk drive (HDD) is used, and information about a manufacturer or distributor of the information processing apparatus 100. Further, the NVMEM 118 or the flash ROM 102 stores information for identifying the information processing apparatus 100 such as a serial number given to the information processing apparatus 100 or a model code indicating a model of the information processing apparatus 100.

An operation unit interface (I/F) 104 is an interface connecting the controller unit 116 and the operation unit 105. The operation unit I/F 104 outputs image data to be displayed on the operation unit 105 to the operation unit 105. Further, the operation unit I/F 104 receives information input by a user from the operation unit 105 and sends the received information to the CPU 101.

A universal serial bus (USB) port 108 is used for connecting a detachably attachable USB device 117 to the information processing apparatus. For example, the USB device 117 can be an external storage device such as a USB memory. The CPU 101 reads information stored in the USB memory through the USB port or retrieves the information from the USB memory. In addition, the CPU 101 writes information to the USB memory through the USB port and saves the information in the USB memory.

A system bus 106 transmits information between the above-described units. An image bus I/F 107 is a bus bridge connecting the system bus 106 to an image bus 113 to convert data communicated between the two buses. The image bus 113 transfers image data at a high speed. The image bus 113 is, for example, a protocol control information (PCI) bus or an IEEE1394 bus.

A raster image processor (RIP) 111 expands vector data such as page description language (PDL) data to bitmap image data. A printer I/F 110 connects the printer 112 and the controller unit 116 to convert image data in a synchronous/asynchronous manner. A scanner I/F 114 connects the scanner 115 and the controller unit 116. An image processing unit 109 corrects, processes, or edits image data obtained by scanning with the scanner 115 or performs correction or resolution conversion on image data to be output from the printer 112. Further, the image processing unit 109 rotates image data or compresses/decompresses multilevel image data in accordance with a JPEG format or compresses/decompresses binary image data in accordance with a JBIG, MMR, or MH format.

The printer 112 prints an image corresponding to raster image data onto a recording medium. The image can be printed by an electrophotography process using a photosensitive drum or belt, or an inkjet process that ejects ink from a micro nozzle array. Any method can be used to print the image. The scanner 115 scans an image on a recording medium and generates image data corresponding to the image.

The operation unit 105 includes a liquid crystal display (LCD) or operation keys. A touch panel sheet is attached on the LCD. The operation unit 105 displays an operation screen of the information processing apparatus 100. In addition, when a user touches any portion of the touch panel, the unit sends positional information about the pressed portion to the CPU 101.

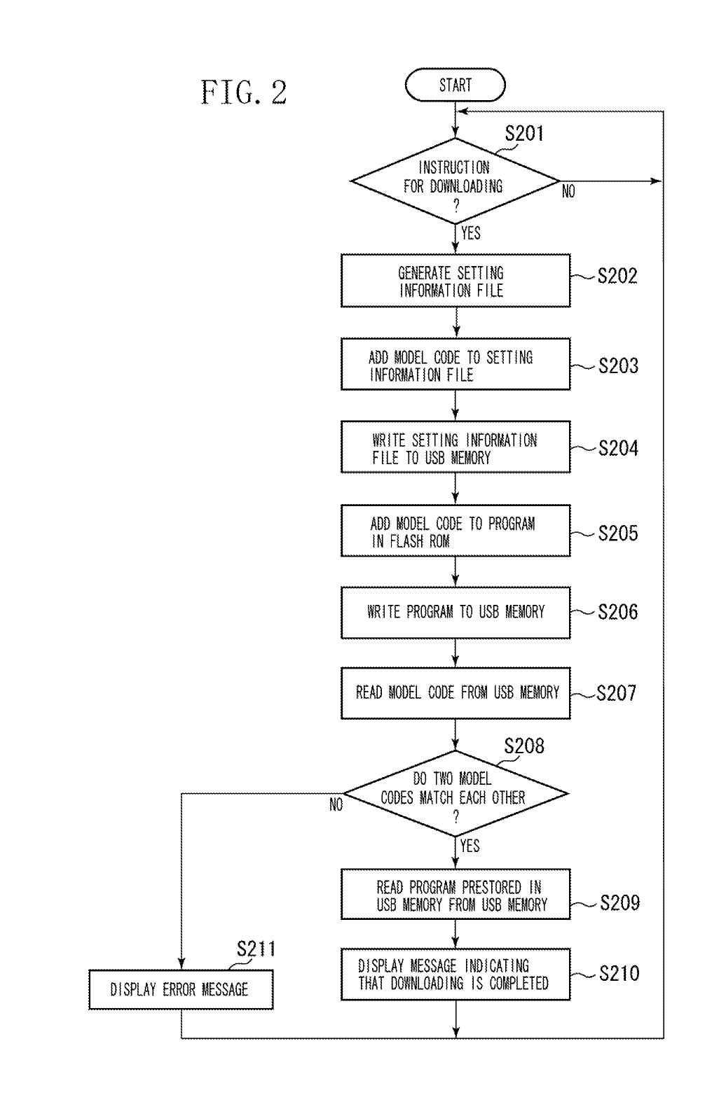

FIG. 2 is a flowchart of a first information processing method executed by the information processing apparatus 100. The CPU 101 executes a program corresponding to the flowchart to carry out the first information processing method.

A user gives a file name “firm.bin” to a program to be stored in the information processing apparatus 100 and saves the program in the USB memory. A model code is added to the program for identifying a model of an information processing apparatus.

Next, the user connects the USB memory to the USB port 108 and issues an instruction for downloading the program from the operation unit 105.

In step S201, the information processing apparatus 100 determines whether the download instruction is sent from the user. If the download instruction is sent (YES in step S201), the information processing apparatus 100 converts setting information stored in the NVMEM 118 to a format that does not depend on a memory and generates a setting information file in step S202. Further, the information processing apparatus 100 adds its model code to the setting information file in step S203. The model code indicates a model of the information processing apparatus 100.

The information processing apparatus 100 gives a file name “Old_Config_file” to the generated setting information file and writes the setting information file to the USB memory in step S204. After writing of the setting information file is completed, the information processing apparatus 100 adds its model code to a program stored in the flash ROM 102 in step S205. Then, the information processing apparatus 100 gives a file name “Old_firm.bin” to the program to which the model code is added, and writes the program to the USB memory in step S206.

As a result, a program or setting information prestored in the information processing apparatus 100 is backed up to the USB memory. Accordingly, if a new program is not adaptable to the information processing apparatus 100, the information processing apparatus 100 can be reset in accordance with the setting information and program backed up to the USB memory.

Next, the information processing apparatus 100 reads the model code added to the program having the file name of “firm.bin” which is stored in the USB memory from the USB memory, and stores the read model code in the RAM 103 in step S207. Then, the information processing apparatus 100 compares the model code read from the USB memory with its own model code to determine whether the two codes match with each other in step S208. If the two model codes match with each other (YES in step S208), the information processing apparatus 100 reads the program having the file name of “firm.bin” from the USB memory in step S209. The apparatus stores the read program in the flash ROM 102.

After downloading of the program is completed, the information processing apparatus 100 displays a message to that effect on the operation unit 105 and informs the user that the program has been downloaded in step S210.

If the two model codes do not match with each other (NO in step S208), the information processing apparatus 100 displays an error message on the operation unit 105 and informs the user that an error occurs in step S211.

Thus, in step S208, the apparatus determines whether the model codes match with each other to prevent a program that is not adaptable to the model of the information processing apparatus 100 from being downloaded to the information processing apparatus 100.

In the example of FIG. 2, the apparatus performs the processing in steps S202 to S206 and then performs the processing in steps S207 and S208. However, the apparatus may perform the determination in steps S207 and S208 before the processing in steps S202 to S206. That is, the apparatus performs the processing in steps S202 to S206 if the two model codes match with each other to skip a back-up step of the setting information and the program.

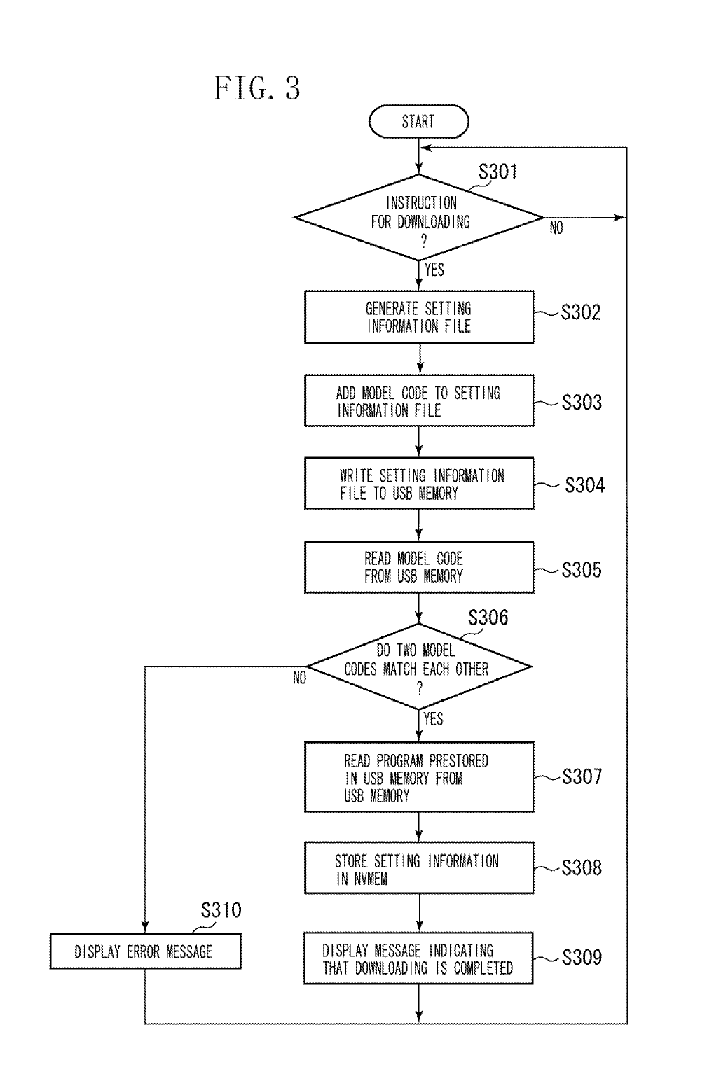

FIG. 3 is a flowchart of a second information processing method performed by the information processing apparatus 100. The CPU 101 executes a program corresponding to the flowchart to carry out the second information processing method.

A user gives a file name “Config_file” to a setting information file generated by the user and saves the setting information file in the USB memory. The setting information file is given a model code for identifying a model of an information processing apparatus.

Next, the user connects the USB memory to the USB port 108 to issue an instruction for downloading setting information from the operation unit 105.

The information processing apparatus 100 determines whether the instruction for downloading setting information is sent from the user in step S301. If the download instruction is received (YES in step S201), the information processing apparatus 100 converts setting information stored in the NVMEM 118 to a format which does not depend on a memory, and generates a setting information file in step S302. Further, the information processing apparatus 100 adds its model code to the setting information file in step S303. The model code indicates a model of the information processing apparatus 100.

The information processing apparatus 100 gives a file name “Old_Config_file” to the generated setting information file and writes the setting information file to the USB memory in step S304.

Next, the information processing apparatus 100 reads the model code added to the setting information file having the file name of “Config_file” that is stored in the USB memory from the USB memory in step S305. The apparatus stores the read model code in the RAM 103. Then, the information processing apparatus 100 compares the model code read from the USB memory with its own model code to determine whether the two codes match with each other in step S306. If the two model codes match with each other (YES in step S306), the information processing apparatus 100 reads the setting information file having the file name of “Config_file” stored in the USB memory from the USB memory and stores the read file in the RAM 103 in step S307. Then, the information processing apparatus 100 converts the setting information file read from the USB memory into setting information of a format that depends on a memory and stores the setting information in the NVMEM 118 in step S308.

When downloading the setting information is completed, the information processing apparatus 100 displays a message to that effect on the operation unit 105 and informs the user that the setting information has been downloaded, in step S309.

If the two model codes do not match with each other (NO in step S306), the information processing apparatus 100 displays an error message on the operation unit 105 and informs the user that an error occurs in step S310.

In step S306, the apparatus determines whether the model codes match with each other to prevent setting information from being downloaded into the information processing apparatus 100 in accordance with a setting information file that is not adaptable to the model of the information processing apparatus 100.

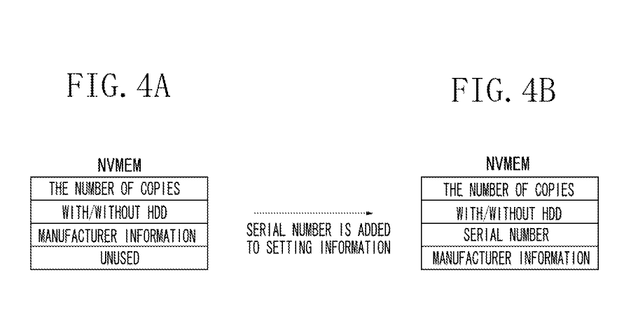

FIGS. 4A and 4B illustrate setting information on a format that depends on a memory. In a state of FIG. 4A, information about the number of copies, information about whether an HDD is necessary, and information about a manufacturer or distributor of the information processing apparatus are stored as setting information in the NVMEM 118. In the state of FIG. 4A, an unused area is left in the NVMEM 118.

When information about a serial number is added as setting information, the state of the NVMEM 118 is changed to the state of FIG. 4B. As a result of adding the information about a serial number, a physical address where the information about a manufacturer is stored is changed. If setting information is backed up by a memory dump, various kinds of information depend on a physical address. Therefore, when the backed-up setting information is reloaded to the information processing apparatus, there is a possibility that the setting information is not correctly loaded. This is because a program of an apparatus of one version or model may be set on premise that information A is stored at a physical address B, while a program of an apparatus of another version or model may be set on premise that the information A is stored at a physical address C.

Accordingly, the information processing apparatus 100 converts the setting information into a setting information file in a format that does not depend on a memory, and then backs up the setting information file to the USB memory. As a result, in the case of storing the setting information in the NVMEM in accordance with a setting information file, the information processing apparatus 100 can store various kinds of information at an appropriate physical address.

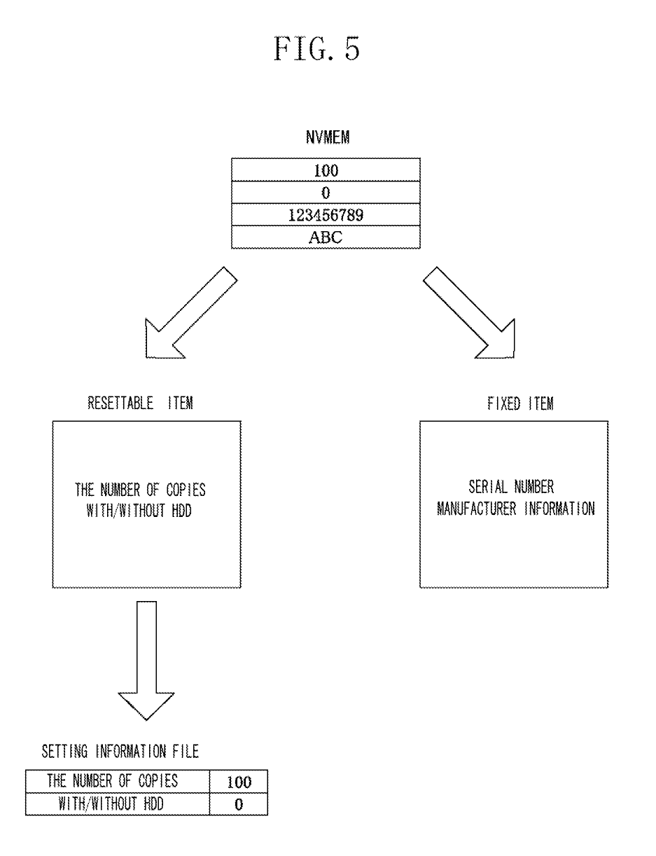

FIG. 5 illustrates an example of a procedure for converting a setting file to a format that does not depend on a memory to generate a setting information file. Setting information stored in the NVMEM 118 is composed of plural setting items. In FIG. 5, “100” is a value representing the number of copies, “0” is a value representing whether an HDD is necessary, “123456789” is a value representing a serial number of the information processing apparatus 100, and “ABC” is information about a manufacturer. The setting information may include information about a sheet size as a default value and information as to whether to print a color image or a monochrome image.

The plural setting items of the setting information are divided into resettable items and fixed items. As for the fixed items, an initial value is used as a set value and thus, the set value does not need to be backed up to the USB memory. Hence, the information processing apparatus 100 extracts resettable items from the plural setting items to generate a setting information file based on set values of the resettable items.

The setting information file is generated in a format that does not depend on a memory and described in a markup language for describing the meaning or structure of a document or data. For example, as illustrated in FIG. 5, detailed information about each setting item and set values in each setting item are described in the setting information file.

As described above, after checking whether model codes match with each other, the information processing apparatus 100 downloads the setting information file or the program. Accordingly, the information processing apparatus 100 can avoid downloading a setting information file or program that is not adaptable to a model of the information processing apparatus 100. Further, the information processing apparatus 100 adds a model code to a setting information file or program backed up to the USB memory to prevent the backed-up setting information file or program from being downloaded to an information processing apparatus of any other model.

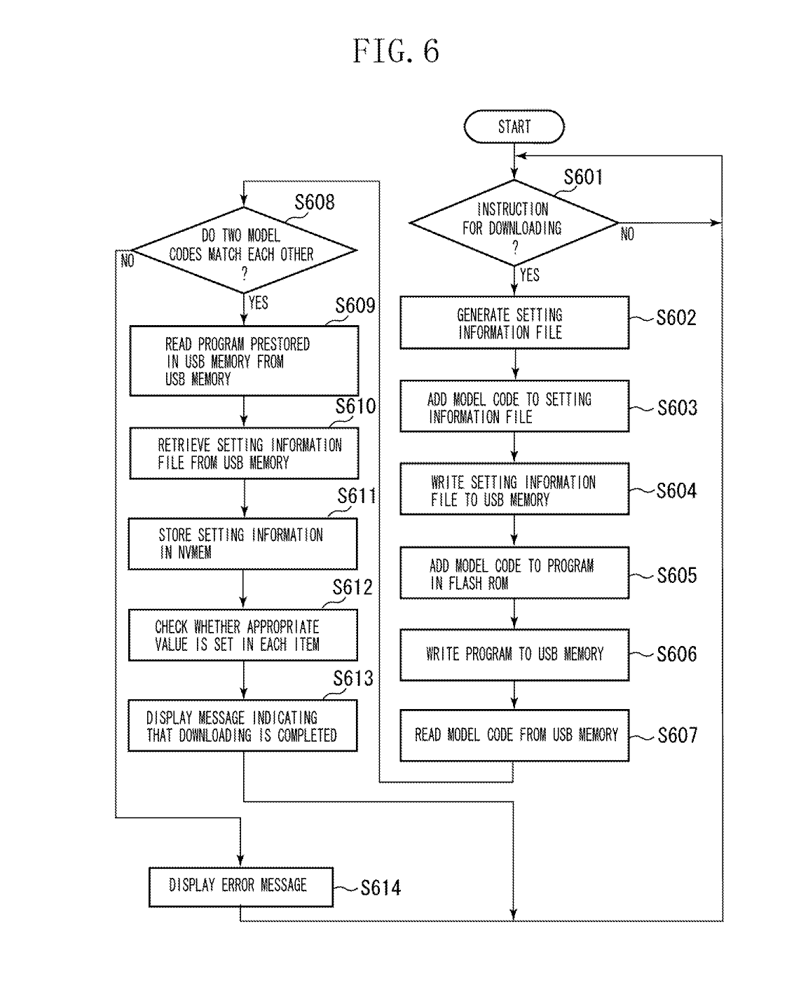

FIG. 6 is a flowchart of a third information processing method executed by the information processing apparatus 100. The CPU 101 executes a program corresponding to the flowchart to carry out the third information processing method.

A user gives a file name “firm.bin” to a program to be stored in the information processing apparatus 100 and stores the program in the USB memory. A version of the program is defined as “1.00”. On the other hand, a version of a program stored in the flash ROM 102 of the information processing apparatus 100 at this point is defined as “2.00”. After that, the user connects the USB memory to the USB port 108. Further, the user issues an instruction for downloading a program from the operation unit 105.

The information processing apparatus 100 determines whether the download instruction is sent from the user in step S601. If the download instruction is sent (YES in step S601), the information processing apparatus 100 converts setting information stored in the NVMEM 118 to a format that does not depend on a memory and generates a setting information file in step S602. Further, the information processing apparatus 100 adds its model code to the setting information file in step S603. The model code identifies a model of the information processing apparatus 100.

The information processing apparatus 100 gives a file name “Old_Config_file” to the generated setting information file and writes the setting information file to the USB memory in step S604. When writing of the setting information file is completed, the information processing apparatus 100 adds its model code to a program stored in the flash ROM 102 in step S605. Then, the information processing apparatus 100 gives a file name “Old_firm.bin” to the program to which the model code is added and writes the program to the USB memory in step S606.

Next, the information processing apparatus 100 reads the model code added to the program having the file name of “firm.bin” that is stored in the USB memory from the USB memory and stores the model code in the RAM 103 in step S607. Then, the information processing apparatus 100 compares the model code read from the USB memory with its own model code to determine whether the two model codes match with each other in step S608.

If the two model codes do not match with each other (NO in step S608), the information processing apparatus 100 displays an error message on the operation unit 105 and informs the user that an error occurs, in step S614.

If the two model codes match with each other (YES in step S608), the information processing apparatus 100 reads the program having the file name of “firm.bin” that is stored by the user from the USB memory in step S609. The read program is stored in the flash ROM 102.

When the program is stored in the flash ROM 102, the information processing apparatus 100 acquires the setting information file having the file name of “Old_Config_file” that is stored in the USB memory from the USB memory in step S610. The information processing apparatus 100 stores setting information in the NVMEM 118 based on the acquired setting information file in step S611.

After that, the information processing apparatus 100 determines whether a value of each setting item of the setting information stored in the NVMEM 118 is adaptable to a program (version “1.0”) that is newly stored in the flash ROM 102 in step S612. If the set value is not adaptable to the program newly stored in the flash ROM 102, a corresponding setting item is reset to an initial value.

When checking of the set values of each setting item is completed, the information processing apparatus 100 displays a message indicating that the program has been downloaded on the operation unit 105 and informs the user that the download is completed in step S613.

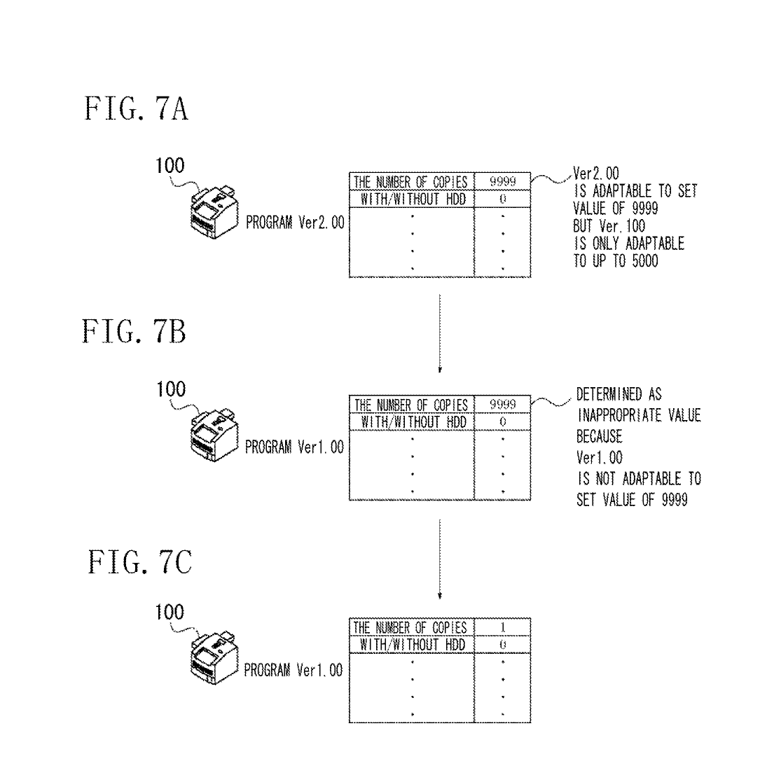

FIGS. 7A to 7C illustrate an example in which an inappropriately set value is described in a setting information file. In a state of FIG. 7A, the information processing apparatus 100 stores a program of the version “2.00” in the flash ROM 102 and operates based on the stored program. Further, “9999” is set as a value representing the number of copies in the setting information. Up to 9999 copies are feasible as to the program of the version “2.00”.

If the information processing apparatus 100 changes the program in the flash ROM 102 from the version “2.00” to the version “1.00” based on the third information processing method, its state is changed to a state of FIG. 7B. At this time, the information processing apparatus 100 stores setting information in the NVMEM 118 in accordance with the setting information file read from the USB memory. Accordingly, “9999” is set as the number of copies.

However, only up to 5000 copies are feasible as to the program of the version “1.00”. Thus, the information processing apparatus 100 considers the number of copies inappropriate for the program of the version “1.00” and changes the number of copies to “1” as shown in a state of FIG. 7C. The initial value of the copy number is “1”.

In the previous embodiments, the model code is added to the setting information file or program. In another embodiment of the present invention, a serial number may be added thereto in place of the model code. The serial number refers to a number uniquely assigned to each information processing apparatus.

The information processing apparatus checks whether serial codes match with each other and then downloads a setting information file or a program so that a setting information file or program that is not adaptable to the information processing apparatus is not downloaded. Further, the information processing apparatus adds a serial number to a setting information file or program backed up to the USB memory so that the backed-up setting information file or program is not downloaded to another information processing apparatus.

According to yet another embodiment of the present invention, a user can select a model code or a serial number as identification information to be added to a setting information file or program.

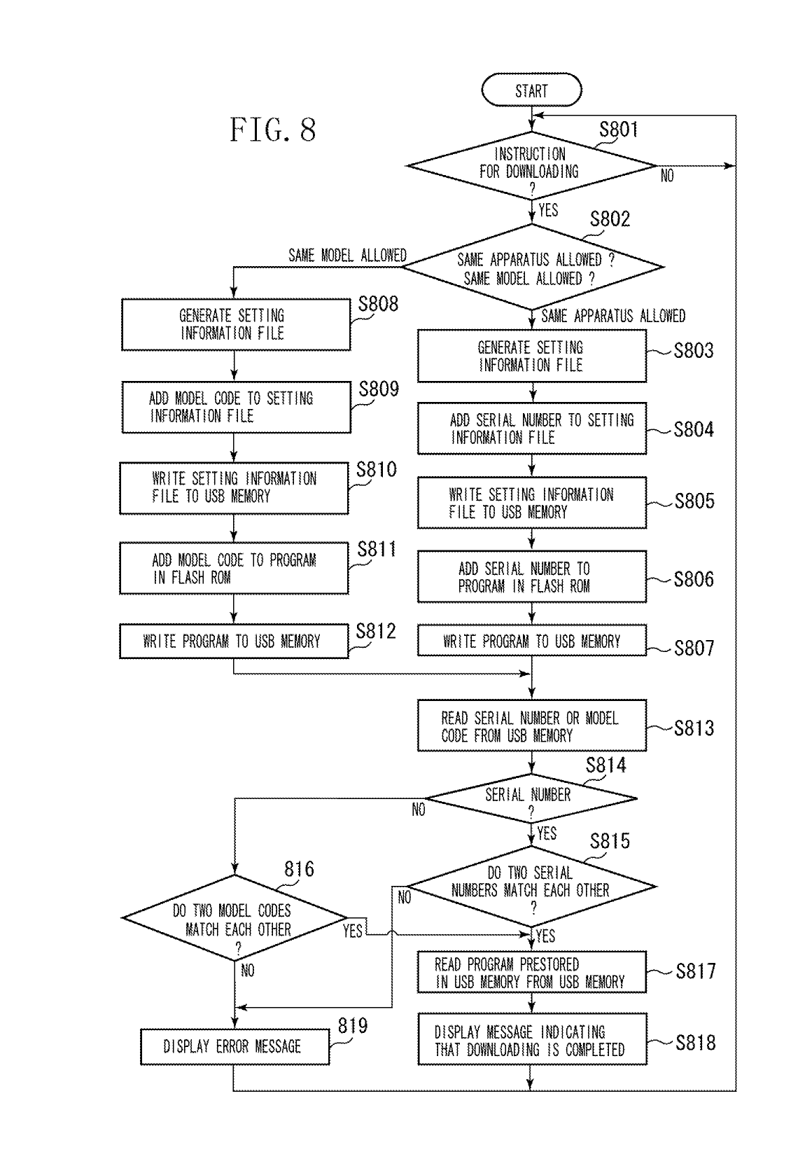

FIG. 8 is a flowchart of a fourth information processing method executed by the information processing apparatus 100. The CPU 101 executes a program corresponding to the flowchart to carry out the fourth information processing method.

A user gives a file name “firm.bin” to a program to be stored in the information processing apparatus 100 and stores the program in the USB memory. In the case where the program is dependent on the information processing apparatus 100 itself, a serial number is added to the program. On the other hand, if the program is dependent on a model, a code indicating a model is added to the program.

Next, the user connects the USB memory to the USB port 108 and issues an instruction for downloading a program from the operation unit 105.

The information processing apparatus 100 determines whether the download instruction is sent from the user in step S801. If the download instruction is sent (YES in step S801), the information processing apparatus 100 displays a screen that offers the user two options on the operation unit 105 and determines whether the user has selected either one of the two choices in step S802. One option is to give permission to download a backed-up program or setting information file only to the information processing apparatus 100. The other option is to give permission to download a backed-up program or setting information file only to information processing apparatuses of the same model as the information processing apparatus 100.

If the user selects the former option, that is, the permission to download a backed-up program or setting information file only to the information processing apparatus 100, the processing advances to step S803. If the user selects the latter option, that is, the permission to download a backed-up program or setting information file only to information processing apparatuses of the same model as the information processing apparatus 100, the processing advances to step S808.

In step S803, the information processing apparatus 100 converts setting information stored in the NVMEM 118 to a format that does not depend on a memory and generates a setting information file. Further, the information processing apparatus 100 adds its serial number to the setting information file in step S804. The serial number is assigned to the information processing apparatus 100.

The information processing apparatus 100 gives a file name “Old_Config_file” to the generated setting information file and writes the setting information file to the USB memory in step S805. When writing of the setting information file is completed, the information processing apparatus 100 adds its serial number to the program stored in the flash ROM 102 in step S806. Then, the information processing apparatus 100 gives a file name “Old_firm.bin” to the program to which the serial number is added and writes the program to the USB memory in step S807.

As a result, the setting information file or program prestored in the information processing apparatus 100 is backed up to the USB memory. The backed-up setting information file or program can be downloaded only to the information processing apparatus 100.

In step S808, the information processing apparatus 100 converts setting information stored in the NVMEM 118 to a format that does not depend on a memory and generates a setting information file. Further, the information processing apparatus 100 adds its model code to the setting information file in step S809. The model code identifies a model of the information processing apparatus 100.

The information processing apparatus 100 gives a file name “Old_Config_file” to the generated setting information file and writes the setting information file to the USB memory in step S810. When writing of the setting information file is completed, the information processing apparatus 100 adds its model code to a program stored in the flash ROM 102 in step S811. Then, the information processing apparatus 100 gives a file name “Old_firm.bin” to the program to which the model code is added and writes the program to the USB memory in step S812.

As a result, the setting information file or program prestored in the information processing apparatus 100 is backed up to the USB memory. Further, the backed-up setting information file or program can be downloaded to information processing apparatuses of the same model as the information processing apparatus 100.

Next, the information processing apparatus 100 reads a serial number or model code added to the program having the file name of “firm.bin” that is stored in the USB memory, from the USB memory in step S813. The serial number or model code is stored in the RAM 103. Then, the information processing apparatus 100 determines whether the serial number or the model code is read from the USB memory in step S814.

If the serial number is read (YES in step S814), the information processing apparatus 100 compares the serial number read from the USB memory with its serial number to determine whether the two numbers match with each other in step S815. If the two numbers match with each other (YES in step S815), the information processing apparatus 100 reads a program stored in the USB memory having the file name of “firm.bin”, from the USB memory in step S817. The read program is stored in the flash ROM 102.

When the program is downloaded, the information processing apparatus 100 displays a message to that effect on the operation unit 105 and informs the user that the download of the program is completed in step S818.

If the two serial numbers do not match with each other (NO in step S815), the information processing apparatus 100 displays an error message on the operation unit 105 and informs the user that an error occurs in step S819.

If the model code is read in step S813 (NO in step S814), the information processing apparatus 100 compares the model code read from the USB memory with its own model code to determine whether the two model codes match with each other in step S816. If the two model codes match with each other (YES in step S816), the processing advances to step S817. If the two model codes do not match with each other (NO in step S816), the processing advances to step S819.

The present invention can be accomplished by directly or remotely supplying a program of software for executing functions of the above exemplary embodiments to a system or apparatus and reading the supplied program with a computer of the system or apparatus. The present invention may be embodied in any form other than the program form, as long as the function of the program can be performed.

Accordingly, the present invention can be also accomplished by a program code installed in a computer to execute functions of the present invention. That is, the scope of the present invention includes a computer program for performing the functions of the present invention. In this case, there is no limitation on a form of the program. That is, an object code, a program executed with an interpreter, and script data supplied to an OS (operating system) can be employed as long as the functions of the program can be performed.

As a recording medium for supplying a program, various mediums can be used. For example, a floppy disk, a hard disk, an optical disk, a magneto-optic disk, an MO, a compact disc-ROM (CD-ROM), a CD-recordable (CD-R), a CD-rewritable (CD-RW), a magnetic tape, a nonvolatile memory card, a ROM, and a digital versatile disc (DVD (DVD-ROM and DVD-R)) may be used.

As another method, a program can be supplied by accessing the Internet website via a browser of a client computer and downloading the program from the website to a recoding medium such as a hard disk. In this case, a computer program of the present invention or a compressed file having an automatic installation function may be downloaded.

Further, the present invention can be embodied by splitting a program code of the program of the present invention into plural files and downloading the files from different websites. That is, a WWW server for downloading to plural users the program files to realize the functions of the present invention with a computer is included in the scope of the present invention.

Further, the present invention can be embodied by encrypting the program of the present invention, storing the program in a recording medium such as a CD-ROM, and supplying the program to users. In this case, only users who satisfy a predetermined condition can download key information for decrypting the program from a website via the Internet to install the encrypted program to a computer so as to execute the program using the key information.

Further, the present invention can be embodied in a form other than the above form in which the functions of the embodiment are realized by the computer executing the read program. For example, in response to a program instruction, an OS running on the computer executes a part or all of the actual processing. The functions of the above embodiments can be also realized in this processing.

Further, the functions of the exemplary embodiments can be realized as follows. That is, a program read from a recording medium may be written to a memory in an expansion board inserted to a computer or an expansion unit connected to the computer. In this case, in response to a program instruction, a CPU in the expansion board or unit executes a part or all of the actual processing.

This application claims priority from Japanese Patent Application No. 2007-028014 filed Feb. 7, 2007, which is hereby incorporated by reference herein in its entirety.

What is claimed is:

1. An information processing apparatus comprising:
a connection unit configured to connect a detachably attachable external storage device;
a program storage unit configured to store a first program;
a first memory control unit configured to store identification information used to identify the information processing apparatus in the external storage device in association with the first program;
a program acquisition unit configured to acquire a second program from the external storage device; and
a second memory control unit configured to store the second program in the program storage unit.

2. The information processing apparatus according to claim 1, further comprising:
a setting information storage unit configured to store setting information set in the information processing apparatus; and
a third memory control unit configured to store the identification information in the external storage device in association with the setting information.

3. The information processing apparatus according to claim 2, further comprising:
a setting information acquisition unit configured to acquire setting information stored in the external storage device;
a determination unit configured to determine whether setting information acquired by the setting information acquisition unit is appropriate for the second program; and
a fourth memory control unit configured to store setting information different from the setting information acquired by the setting information acquisition unit in the setting information storage unit if the setting information acquired by the setting information acquisition unit is inappropriate for the second program.

4. The information processing apparatus according to claim 2, further comprising:
a conversion unit configured to convert the setting information into a format that is not dependent on the memory structure of the setting information storage unit,
wherein the third memory control unit stores setting information converted by the conversion unit and the identification information in the external storage device.

5. The information processing apparatus according to claim 1, further comprising:
a comparison unit configured to compare identification information corresponding to the second program stored in the external storage device with identification information used to identify the information processing apparatus,
wherein if the identification information corresponding to the second program and the identification information used to identify the information processing apparatus match, the program acquisition unit acquires the second program from the external storage device.

6. The information processing apparatus according to claim 1, further comprising:
a selection unit configured to allow a user to select identification information to be stored in the external storage device by the first memory control unit from a plurality of pieces of identification information,
wherein the first memory control unit stores the first program and identification information selected by the user in the external storage device.

7. An information processing apparatus comprising:
a connection unit configured to connect a detachably attachable external storage device;
a setting information storage unit configured to store setting information set in the information processing apparatus;
a first memory control unit configured to store identification information used to identify the information processing apparatus in the external storage device in association with first setting information stored in the setting information storage unit;
a setting information acquisition unit configured to acquire second setting information to be set in the information processing apparatus from the external storage device; and
a second memory control unit configured to store second setting information acquired by the setting information acquisition unit in the setting information storage unit.

8. An information processing apparatus comprising:
a connection unit configured to connect a detachably attachable external storage device;
a program storage unit configured to store a first program;
a program acquisition unit configured to acquire a second program from the external storage device;
a first memory control unit configured to store the second program in the program storage unit;
a setting information storage unit configured to store setting information set in the information processing apparatus; and
a second memory control unit configured to store identification information used to identify the information processing apparatus in the external storage device in association with setting information stored in the setting information storage unit.

9. A method executed in an information processing apparatus connectable with a detachably attachable external storage device, the method comprising:
storing a first program;
storing identification information used to identify the information processing apparatus in the external storage device in association with the first program;
retrieving a second program from the external storage device; and
storing the acquired second program.

10. The method according to claim 9, further comprising:
storing setting information set in the information processing apparatus; and
storing the identification information in the external storage device in association with the setting information.

11. The method according to claim 10, further comprising:
converting stored setting information into a format that is not dependent on a physical memory structure where the setting information is stored; and
storing the converted setting information and the identification information in the external storage device.

12. The method according to claim 10, further comprising:
acquiring setting information stored in the external storage device;
determining whether the acquired setting information is appropriate for the second program; and
storing setting information different from the retrieved setting information if the acquired setting information is inappropriate for the second program.

13. The information processing method according to claim 9, further comprising:
comparing identification information corresponding to the second program stored in the external storage device, with identification information used to identify the information processing apparatus; and
acquiring the second program from the external storage device when the identification information corresponding to the second program matches the identification information used to identify the information processing apparatus.

14. The method according to claim 9, further comprising:
allowing a user to select identification information to be stored in the external storage device from a plurality of pieces of identification information; and
storing the first program and identification information selected by the user in the external storage device.

15. A method executed in an information processing apparatus connectable with a detachably attachable external storage device, the method comprising:
storing identification information used to identify the information processing apparatus in the external storage device in association with first setting information;
acquiring second setting information to be set in the information processing apparatus; and
storing the acquired second setting information.

16. A method executed in an information processing apparatus that is connectable with a detachably attachable external storage device, the method comprising:
acquiring a program from the external storage device;
storing the acquired program; and
storing identification information used to identify the information processing apparatus in the external storage device in association with stored setting information.
